(19) United States
(12) Patent Application Publication
(10) Pub. No.: US 2005/0135109 A1
(43) Pub. Date: Jun. 23, 2005

(54) Light blade

(75) Inventor: Bo J. Stout, Indianpolis, IN (US)

Correspondence Address: RUSSELL E. FOWLER, II, ICE MILLER, ONE AMERICAN SQUARE, BOX 82001, INDIANAPOLIS, IN, 46282-0002, US

(73) Assignee: GUIDE CORPORATION, a Delaware Corporation, Pendleton, IN (US)

(21) Appl. No.: 10/738,527

(22) Filed: Dec. 17, 2003

(51) Int. Cl. F21V 1/00

(52) U.S. Cl. 362/509

(57) ABSTRACT

A light assembly is provided which divides a collimated light beam into a plurality of beams using the principle of total internal reflection. A portion of the beam exits a lens in a direction generally parallel to the optical axis of the collimated light beam. A surface within the lens is located such that a portion of the collimated light beam impinges the surface at an angle greater than the critical angle, causing the portion of collimated light to be reflected within the lens. The redirected portion of the collimated light beam may then be used for other purposes such as providing an ornamental feature.

### BACKGROUND OF THE INVENTION

Generally, conventional automotive lighting systems utilize filament bulbs as a lighting source. However, filament bulbs have many drawbacks, including high consumption of electrical power, the generation of great amounts of heat, and readily breakable filaments. Recently, due to these drawbacks, light emitting semiconductor devices (LESDs), such as light emitting diodes (“LEDs”), have been adapted for use in certain automobile lighting systems.

LEDs solve many of the problems associated with filament bulbs, because they emit light using a lower voltage and current than used by a filament bulb and are less prone to breakage. However, various other problems are associated with LEDs when used in automobile lighting systems. For example, surface emitting LEDs use a substantially planar luminescent element which radiates high intensity light predominantly in the forward direction, and only minimal light energy is emitted toward the sides. A typical surface emitting LED will actually have peak intensity at +/−20 to 30 degrees off normal. Nonetheless, this type of LED can be generally modeled as a Lambertian source. That is, a source wherein the intensity of the light emitted is subject to the cosine law as given by the formula:
I=Iₒ cos θ
wherein I is the resultant intensity, Iₒ is the intensity normal to the surface, and θ is the angle between normal and the viewing direction.

In a typical automotive application, the light emitted from a light source is collimated, focusing the emitted light into a narrow beam within 10 degrees of the optical axis. Collimators known to be used with LEDs include those that operate according to the principle of total internal reflection (TIR). TIR is reflection that occurs due to refraction when the angle of incidence of light traveling in a given substance strikes a boundary surface in excess of the critical angle. The critical angle is the angle of incidence in a denser medium, at an interface between the denser and a less dense medium, that is defined by the equation:
sin I_{c}=n′/n
where I_{c} is the critical angle, n′ the refractive index of the less dense medium, and n the refractive index of the denser medium. TIR is a desirable mechanism because it is more efficient in reflecting light than is utilizing a reflective surface, such as a mirror.

However, as the intensity of LEDs increases through various technological advances, the focusing of the emitted light creates a total emission that can exceed the desired intensity. It is, of course, possible to simply use an LED with a lower output. However, it is also desired to reduce the total number of light sources required for a vehicle. Accordingly, it would be beneficial to split the emitted beam into a plurality of beams, either to provide additional ornamentality or to reduce the total number of light sources required for a given application, while minimizing reflection losses.

Therefore, a need exists for an automotive lighting system that provides for the use of LEDs within the lighting system while reducing the number of LEDs needed. It is preferred that the system efficiently create a plurality of light beams. It would be further beneficial if the system used commonly available materials and minimized the number of parts in the system.

### BRIEF SUMMARY OF THE INVENTION

In accordance with the present invention, a light assembly is provided which overcomes the disadvantages of the prior art by providing for partial redirection of a beam of collimated light. A lens is provided that allows some of the collimated light to pass through, while another portion of the collimated light is diverted from the original beam. According to one embodiment, the collimated beam is split by using the principle of TIR. Thus, a portion of the collimated beam provides the main beam of a taillight, while another portion of the collimated beam is used to provide a design feature.

### BRIEF DESCRIPTION OF THE DRAWINGS

FIG. 1 is a cross-sectional view of a light subassembly.

FIG. 2 is a cross-sectional view of a light assembly in accordance with the present invention incorporating the light subassembly of FIG. 1, taken along line B-B of FIG. 3.

FIG. 3 is a top plan view of the light assembly of FIG. 2.

FIG. 4 is a cross-sectional view of the light assembly of FIG. 2, taken along line C-C of FIG. 3.

FIG. 5 is a perspective view of the light assembly of FIG. 2.

FIG. 6 is a perspective view of an alternative embodiment of a light assembly according to the present invention.

FIG. 7 is a perspective view of an alternative embodiment of a light assembly according to the present invention.

### DETAILED DESCRIPTION OF THE INVENTION

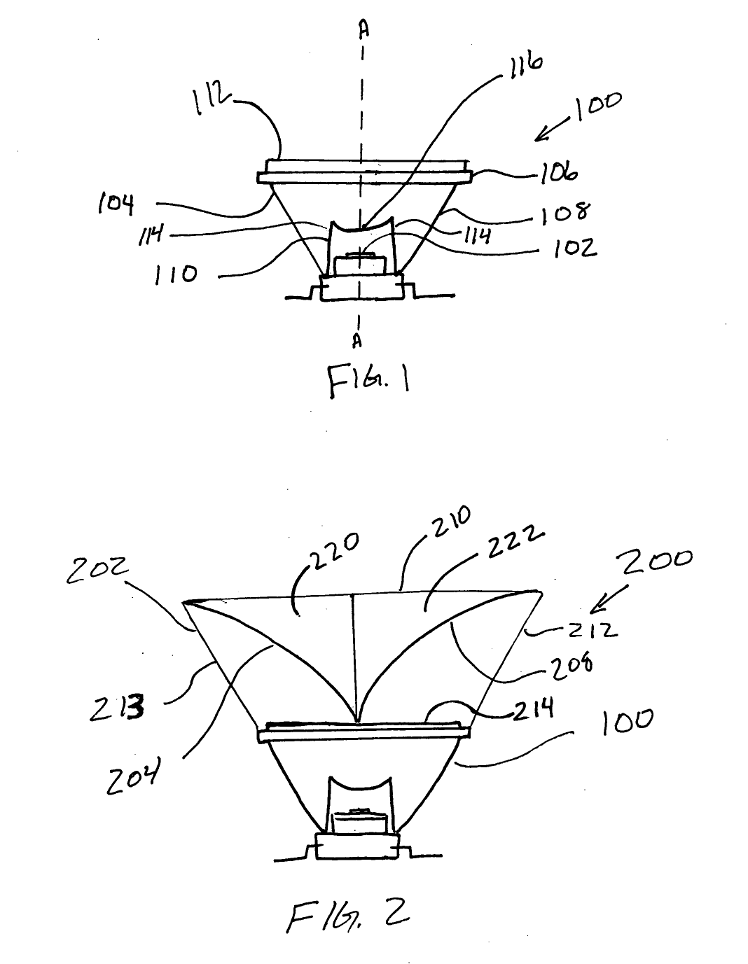

Shown in FIG. 1 is a cross-section view of light subassembly 100. Light sub assembly 100 comprises LED 102 and collimator 104. Collimator 104 comprises ledge 106, side 108, LED mating area 110 and top 112. Collimator 104 is manufactured from a clear substance such as acrylic. Suitable collimators are available from Lumileds Lighting, LLC of San Jose Calif., such as model LXHL-NX05-Luxeon™ Collimator.

LED mating area 110 includes vertical wall 114 and convex wall 116. Vertical wall 114 is designed to refract light from LED 103 so that light entering collimator 104 through vertical wall 114 impinges on side 108 at an angle in excess of the critical angle. Accordingly, light entering collimator 104 through vertical wall 114 will be internally reflected by side 108. Side 108 is angled so that the light reflecting off of side 108 is collimated, and travels parallel to the optical axis of LED 102 which is indicated in FIG. 1 by line A-A. Convex wall 116 is designed so that light entering collimator 104 through convex wall 114 is refracted and collimated, and travels parallel to optical axis A-A. Accordingly, a collimated beam of light passes through top 112.

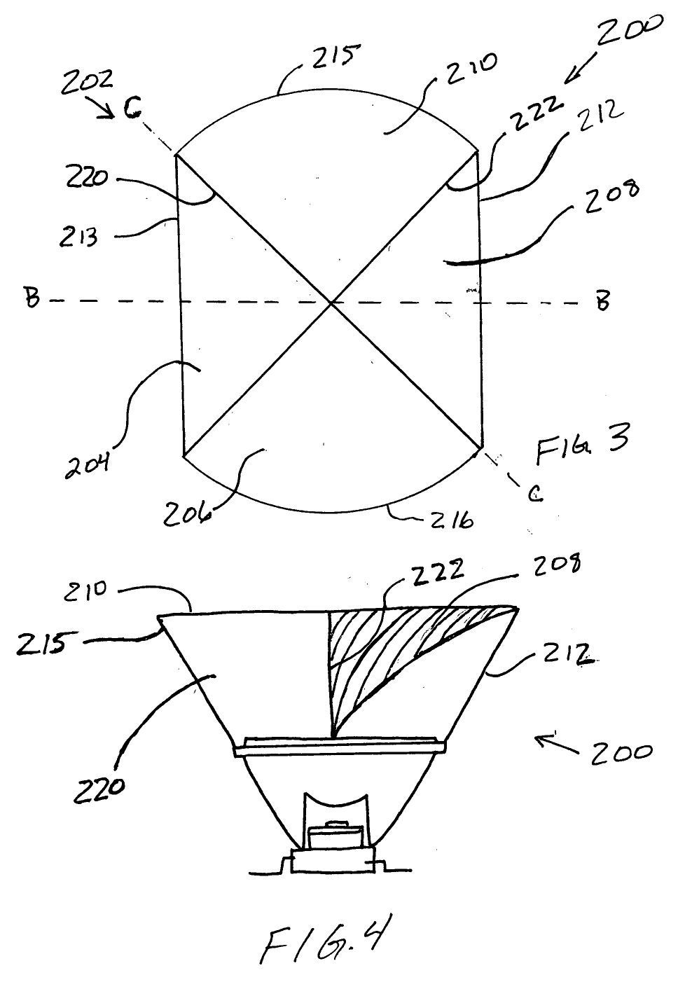

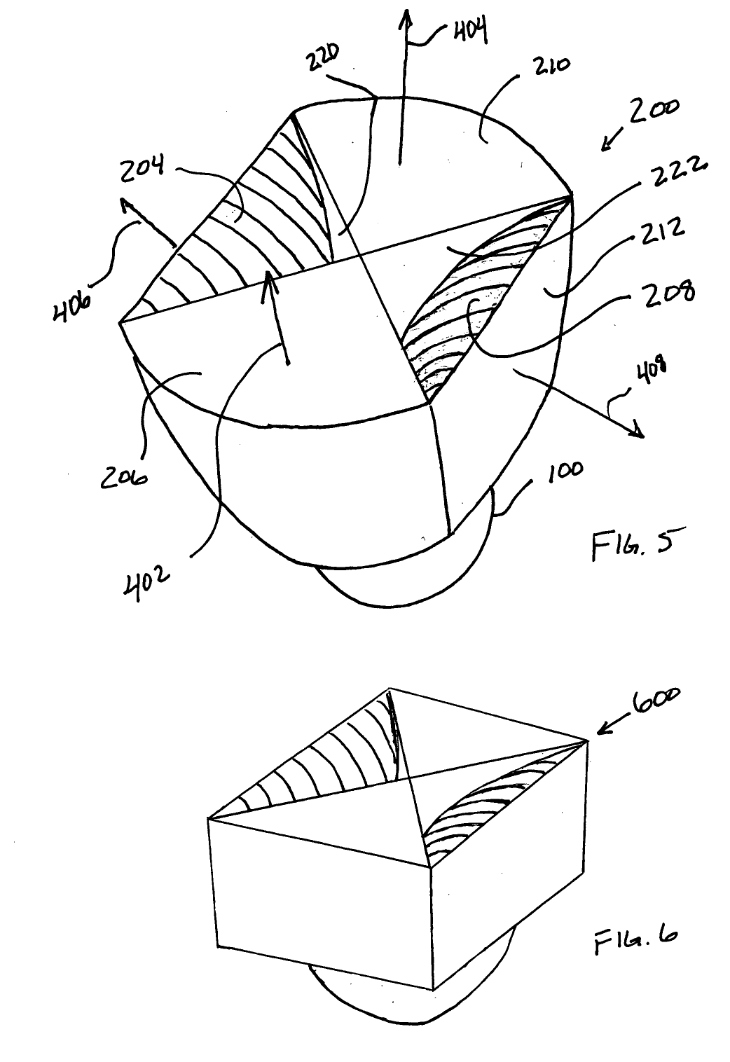

One embodiment of the present invention comprising the light subassembly of FIG. 1 is described in reference to FIGS. 2-4. FIG. 2 is a cross sectional view of light assembly 200 taken along line B-B of FIG. 3. FIG. 3 is a top plan view of light assembly 200. Referring now to FIG. 2, light assembly 200 includes light sub assembly 100 and lens 202. In this embodiment, lens 202 includes semi-parabolic wall 204, planar wall 206, semi-parabolic wall 208, planar wall 210, side walls 212, 213, 215 and 216, bottom 214, and inner walls 220 and 222. Bottom 214 is designed to fit over top 112 of collimator 104 and be secured against ledge 106. As shown most clearly in FIGS. 2, 3 and FIG. 5, semi-parabolic wall 204 and semi-parabolic wall 208 are wedge shaped sections having a semi-parabolic curve toward the center of lens 200. Planar wall 201 and planar wall 204 are also wedge shaped as viewed in FIG. 3, and are flat. FIG. 4 is a cross sectional view of light assembly 200 taken along line C-C of FIG. 3. Shown in FIG. 4 are side walls 212 and 215, planar wall 210 and semi-parabolic wall 208.

The shape of semi-parabolic walls 204 and 208 are selected such that light from LED 102 that exits top 112 of collimator 104 and enters bottom 214 of lens 202 will impinge semi-parabolic walls 204 and 208 at an angle in excess of the critical angle. Accordingly, light impinging on semi-parabolic walls 204 and 208 is reflected by TIR and does not pass through semi-parabolic walls 204 and 208. The shape of planar walls 206 and 210 are selected such that some of the light from LED 102 exits top 112 of collimator 104 and enters bottom 214 of lens 202, passes through lens 202 and impinges planar walls 206 and 210 at an angle less than the critical angle for planar walls 206 and 210. Accordingly, light impinging on planar walls 206 and 210 may be refracted, but will pass through planar walls 206 and 210.

The splitting of a collimated light beam entering bottom 214 of lens 202 is shown with reference to FIG. 5. The collimated light that does not strike semi-parabolic walls 204 and 208 passes through planar walls 206 and 210 as indicated by light rays 402 and 404. Light impinging on semi-parabolic walls 204 and 208, however, is reflected. The angle at which the reflected collimated light impinges side walls 212 and 213 is less than the critical angle. Accordingly, as shown by light rays 406 and 408, the collimated light reflecting off of semi-parabolic walls 204 and 208 respectively, passes through side walls 213 and 212 along a plane normal to optical axis A-A shown in FIG. 1.

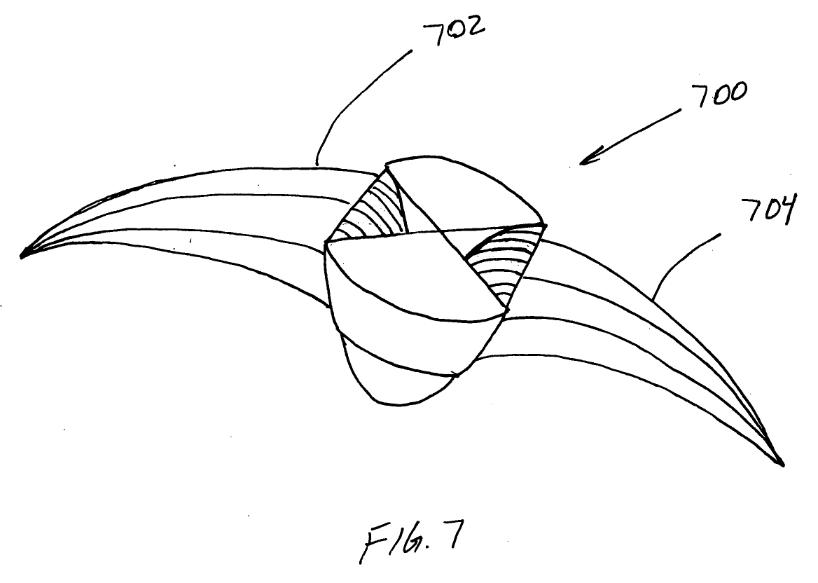

Those of skill in the art will recognize that in accordance with the present invention, the shape of the lens and the overall shape of the light assembly could be varied to generate a variety of unique appearances, provided that the optical and photometric requirements of the light assembly are still satisfactory. By way of example, but not of limitation, FIG. 6 shows an alternative shape of a light assembly incorporating lens 600. Moreover, once portions of the collimated light have been redirected, they may be further redirected for use such as providing ornamental appeal to a vehicle. For example, as shown in FIG. 7, the light from light assembly 700 may be directed into shaped light pipes 702 and 704, so as to cause the light pipes to “glow”. Of course, the shape of the light pipes is a design choice. Moreover, the light pipes may be formed as an integral part of the lens.

Moreover, while the embodiment of FIGS. 1-5 allows approximately fifty percent of the light from LED 102 to pass through walls 206 and 210, this can be altered within the scope of the present invention. For example, the amount of light emitted through the lens in the direction of the optical axis of the LED may be greater than or less than fifty percent. Additionally and/or alternatively, there may be a fewer or a greater number of walls. In yet another embodiment, the light passing through the walls is refracted, so as to direct the emitted light off of the optical axis of the LED or other light source.

Those of skill in the art will realize that as described herein, the present invention provides significant advantages over the prior art. The invention provides a light assembly which provides for the use of LEDs within the lighting system of a vehicle while reducing the number of LEDs needed. Moreover, the present invention efficiently create a plurality of light beams. Additionally, the present invention uses commonly available materials without unduly increasing the number of parts in the lighting system.

While the present invention has been described in detail with reference to certain exemplary embodiments thereof, such are offered by way of non-limiting example of the invention, as other versions are possible. It is anticipated that a variety of other modifications and changes will be apparent to those having ordinary skill in the art and that such modifications and changes are intended to be encompassed within the spirit and scope of the invention as defined by the following claims.

1. An automobile light lens for splitting collimated light into a plurality of beams, the lens comprising:
a first surface oriented with respect to the collimated light such that a first portion of the collimated light is allowed to pass through the first surface and out of the lens;
a second surface oriented with respect to the collimated light such that a second portion of the collimated light is reflected off of the second surface by total internal reflection; and
a third surface oriented with respect to the second surface such that the second portion of the collimated light reflected off of the second surface is allowed to pass through the third surface and out of the lens.

2. The automobile light lens of claim 1, wherein the second surface is a generally semi-parabolic surface.

3. The automobile lens of claim 1, wherein the lens further comprises:
a fourth surface oriented with respect to the collimated light such that a third portion of the collimated light is allowed to pass through the third surface and out of the lens; and
a fifth surface oriented with respect to the collimated light such that a fourth portion of the collimated light is reflected off of the second surface by total internal reflection and out of the lens.

4. The automobile lens of claim 3, wherein:
the first and the third portion of the collimated light comprises about fifty per-cent of the collimated light passing out of the lens, the first and third portion of the collimated light passing out of the lens in a first direction;
the second portion of the collimated light is reflected by the second surface in a direction approximately normal to the first direction; and
the fourth portion of the collimated light is reflected by the fifth surface in a direction approximately normal to the first direction.

5. An automobile lighting assembly comprising:
a generally lambertian light source;
a collimator in optical communication with the light source and oriented with respect to the light source such that light from the light source that impinges the collimator is collimated; and
a lens, the lens comprising:
a first surface oriented with respect to the collimator such that some of the collimated light is allowed to pass through the first surface and out of the lens;
a second surface oriented with respect to the collimator such that some of the collimated light that does not pass through the first surface is reflected off of the second surface by total internal reflection; and
a third surface oriented with respect to the second surface such that the collimated light reflected off of the second surface is allowed to pass through the third surface and out of the lens.

6. The automobile lighting assembly of claim 5, wherein the lens and collimator are molded as an integral unit.

7. The automobile lighting assembly of claim 6, further comprising, a light pipe.

8. The automobile lighting assembly of claim 6, wherein the collimated light reflected by the second surface is reflected in a direction approximately normal to the first direction.
